(19) United States
(12) Patent Application Publication
(10) Pub. No.: US 2003/0062387 A1
(43) Pub. Date: Apr. 3, 2003

(54) Dosing device for use with a gable top container and kit containing same

(75) Inventors: Luca Diamanti, Rome (IT); Alessandro Algozzino, Colleferro (IT)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/186,110

(22) Filed: Jun. 28, 2002

Related U.S. Application Data
(60) Provisional application No. 60/302,966, filed on Jul. 5, 2001.

(51) Int. Cl. B67D 5/38; G01F 19/00

(52) U.S. Cl. 222/158; 73/427

(57) ABSTRACT

A dosing device for a flowable composition for use in association with a gable top container having at least one angled upper surface. The dosing device has a bottom, a first sidewall connected to the bottom, preferably a second sidewall connected to the bottom and the first sidewall, and means for affixing the dosing device to a gable top container such that the device rests on an angled upper surface of the gable top container. The second sidewall may be trapezoidal in shape or in the alternative, oriented at an obtuse angle relative to said first sidewall. Preferably, the means for affixing the dosing device to the container is a channel for receiving a vertical ridge extension from the top of the gabled container. A kit for containing and dosing a flowable composition that includes a dosing device and a gable top container. Preferably, when the dosing device rests on the angled upper surface it provides a planar surface that is substantially perpendicular to a planar sidewall of the container.

### CROSS REFERENCE TO RELATED APPLICATIONS

This application claims priority under 35 U.S.C. §119(e) to U.S. Provisional Application Serial No. 60/302,966, filed Jul. 5, 2001 (Attorney Docket No. 8627P).

### BACKGROUND OF THE INVENTION

Gable top containers are well known for use in containing flowable compositions and products. Perhaps the most well known gable top container is the common milk carton. Such containers are commonly used to contain and dispense all manner of liquids, powders and granulated products.

The use of a dosing or dispensing device in association with a flowable product for measuring an appropriate or desired amount of a given composition is also known. Further still, there are many examples in the container and packaging arts where threaded caps and closures have been specially designed to provide a dosing capability in addition to their closure function. However, dosing devices specifically designed for use in association with or storage on a gable top container is not known.

### SUMMARY OF THE INVENTION

The present invention provides a dosing device for a flowable composition for use in association with a gable top container having at least one angled upper surface, said dosing device comprising a bottom, a first sidewall connected to the bottom, a second sidewall connected to the bottom and the first sidewall, and means for affixing the dosing device to a gable top container such that the device rests on an angled upper surface of the gable top container. The second sidewall may be trapezoidal in shape or in the alternative, oriented at an obtuse angle relative to said first sidewall. Optionally, the dosing device may have demarcations that would aid the user in identifying the amount of product in the device. Further, a portion of the dosing device may optionally be transparent or translucent to enable the user to view the flowable composition within the device. Preferably, the means for affixing the dosing device to the gable top container is a flange affixed to a sidewall that is spaced apart and substantially parallel to the first sidewall creating a channel for receiving a vertical ridge extension from the top of the container.

In a further aspect of the present invention, there is provided a kit for containing and dosing a flowable composition. The kit comprises a gable top container for containing the flowable composition, said container having at least one angled upper surface, and a dosing device for dosing the composition. The dosing device comprises means for affixing the device to the gable top container such that the device rests on the angled upper surface of the container. Preferably, when the dosing device rests on the angled upper surface it provides a planar surface that is substantially perpendicular to a planar sidewall of the container.

### BRIEF DESCRIPTION OF THE DRAWINGS

FIG. 1 is a perspective view of a dosing device of the present invention.

FIG. 2 is an elevated view of the device shown in FIG. 1.

FIG. 3 is a side view of the dosing device shown in FIG. 1.

FIG. 4 is a perspective view of alternative embodiment of the dosing device of the present invention.

FIG. 5 is a perspective view of a kit of the present invention wherein the dosing device shown in FIG. 1 rests on the gable top of the container.

### DETAILED DESCRIPTION OF THE INVENTION

The present invention relates to dosing devices that may be attached to a gable top container and that rest on an angled upper surface of the container. The present invention further pertains to a kit comprising a gable top container and such a dosing device.

As used herein, “gable top container” refers to any container that has one or more angled upper surfaces and a ridge extension that extends generally vertically above the angled upper surface. Perhaps the most well known form is the milk carton-type container which is generally a box-like container having a top that has two angled upper surfaces that meet to form a central ridge and from which a ridge extension extends upward. However, the dosing devices of the present invention are not limited to this particular type of container, but may be used in association with any container having at least one upper angled surface. Further, the type of flowable composition stored in a given container should not be taken as limiting of the present dosing devices.

As used herein, “angled upper surface” refers to an upper surface of a container that has an acute angle relative to horizontal when the container is at rest on a generally horizontal surface.

The dosing device of the present invention is preferably manufactured from a variety of commercially available polymeric materials and may be formed using a variety of conventional manufacturing techniques. More particularly, it is preferred that the dosing device of the present invention be made from polypropylene, polyethylene, derivatives thereof, or mixtures thereof. Further, the dosing devices may be made using conventional injection molding techniques as well as blow molding processes, with injection molding being preferred.

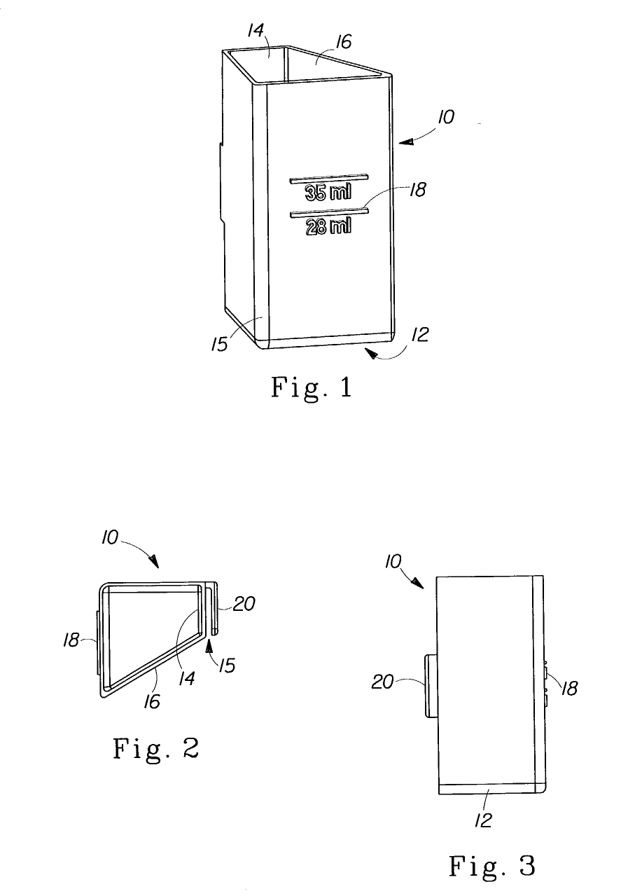

As shown in FIG. 1, dosing device 10 comprises a bottom 12, first sidewall 14, a second sidewall 16, and means for affixing the device to a gable top container, an example of such affixing means being more clearly shown in FIG. 2 as flange 20. Preferably, one of the sidewalls will bear demarcations 18 that are volumetric units of measure so as to guide the user in filling and subsequently dispensing an appropriate or desired amount of the flowable product. Optionally, but preferably, dosing device 10 will have a portion 15 that is transparent or translucent to aid the consumer in identifying the level of product within the dosing device.

As shown in FIG. 2, bottom 12 is trapezoidal in shape. Opposite bottom 12 is an opening for filing the dosing device with a flowable composition from a container. Second sidewall 16 is oriented at an obtuse angle relative to first sidewall 14. The angle between first sidewall 14 and second sidewall 16 will be determined by angle of the upper surface of the container with which the dosing device is used. More specifically, the obtuse angle between the first and second sidewalls should be such that second wall 16 rests relatively flat on the angled upper surface of the container.

Flange 20, is attached to dosing device 10 and spaced apart from first sidewall 14. The location at which flange 20 attachs to device 10 is not critical. However, flange 20 and sidewall 14 should define channel 15 for receiving the ridge extension of a gable top container. Frictional engagement between the internal surfaces of channel 15 and the ridge extension should be sufficient to secure dosing device 10 to the top of the container. In use, dosing device 10 is simply lifted from the gable top container, the container is opened and an appropriate or desired amount of flowable product is poured into dosing device 10. Means for affixing device 10 to a container other than flange 20 will include other structures that will enable the device to be secured to the ridge extension of the container. Clips with a resilient mechanism, elastic bands, as well as adhesives and hook and loop materials applied to the upper angled surface of the container may all provide means for affixing device 10 to a gable top container. These latter means may be most preferred when the gable top container lacks a vertical ridge extension.

The width of flange 20 as measured along a line parallel to sidewall 14 may be relatively narrow as shown in FIG. 3. Unlike container 70 that is shown in FIG. 5 and which has cap 78, many gable top containers are opened by pulling the two angled upper surfaces apart at the ridge to reveal a folded spout that is then pulled out to enable flowable product to be dispensed from the container. Such containers are closed by pushing the spout back in and pressing the two angled upper surfaces together. However, there is generally no structure or means to assure that the two angled upper surfaces remain in a closed position. The result is that product commonly leaks from the previously opened container during transport or handling. Therefore, it is envisioned that flange 20 may be extended along first sidewall 14 to the bottom end and/or the opening end of device 10. With such a configuration, flange 20 will retain the two halves of the ridge extension in a closed position when the device is fixed on the gable top container.

FIG. 5 shows device 10 fixed to the gable top container 70. Container 70 has angled upper surfaces 74 and ridge extension 72 that is received within channel 15 to secure the dosing device to the container. Preferably, when device 10 rests on the angled upper surface 74 it provides a flat surface 75 that is substantially perpendicular to a planar sidewall 76 of container 70. It is envisioned that surface 75 will aid in the packing of gable top containers by providing a flat surface on which to stack additional containers. Additionally, it is envisioned that surface 75 may be modified to extend across ridge extension 72 to further aid in providing this stacking feature.

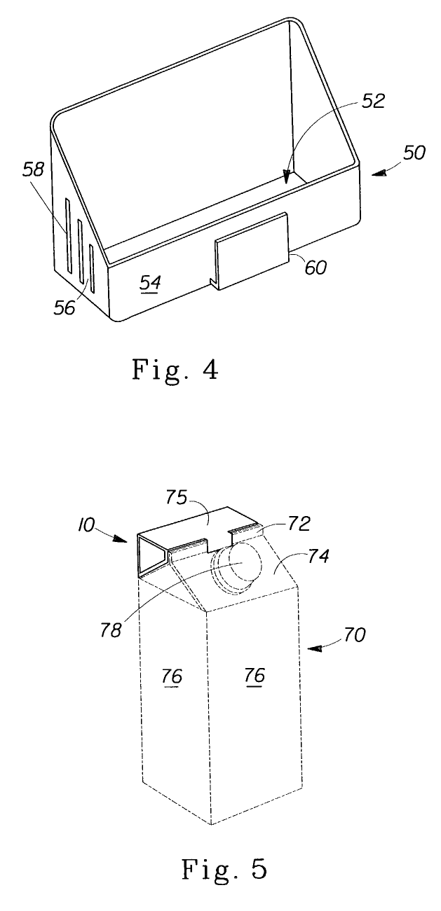

In an alternative embodiment of the dosing device of the present invention, as shown in FIG. 4, dosing device 50 comprises bottom 52, a first sidewall 54, a second sidewall 56, and means for affixing the device to a gable top container, illustrated as flange 60. Dosing device 50 is also provided with ridges 58 externally extending from opposite sidewalls to aid the user in gripping the dosing device. Alternatively, a recess (not shown) may be formed in opposite sidewalls of the device as alternative gripping means.

As shown in FIG. 4, second sidewall 56 is trapezoidal in shape. Second sidewall 56 has a pair of parallel edges, a third edge that is perpendicular to the pair of parallel edges, and a fourth edge that is at an acute angle relative to the third edge. This acute angle will be determined by the angled upper surface of the container on which the dosing device will rest so that the device will rests relatively flat on the angled upper surface. Contrary to device 10 described above, second sidewall 56 does not lie flat against the upper angled surface of the container. Rather, the angled edge of second sidewall 56 will lie along the upper angled surface of the container when device 50 is inverted and fixed to the container.

Flange 60 and first sidewall 54 define a channel there between for receiving and frictionally engaging with the ridge extension of the container to thereby fix the device to the container. Again, it is preferred that when inverted and fixed to the container, the dosing device will provide a relatively flat planar surface that is perpendicular to the side walls of the container so as to aid in stacking/packing multiple containers.

The opening of device 50 is opposite bottom 52 and is an enlarged opening. Because of the enlarge nature of the opening for dosing device 50, it may be preferred for non-liquid flowable products such as powders and particulates.

While particular embodiments of the present invention have been illustrated and described, it will be obvious to those skilled in the art that various changes and modifications can be made without departing from the spirit and scope of the invention, and it is intended to cover in the appended claims all such modifications that are within the scope of this invention.

What is claimed is:

1. A dosing device for a flowable composition for use in association with a gable top container having at least one angled upper surface, said dosing device comprising:
a bottom;
a first sidewall connected to the bottom; and
connected to the first sidewall or bottom, means for affixing the dosing device to a gable top container such that the device rests on an angled upper surface of the gable top container.

2. The dosing device of claim 1, further comprising a second sidewall.

3. The dosing device of claim 2, wherein the second sidewall is trapezoidal in shape.

4. The dosing device of claim 2, wherein the second sidewall is oriented at an obtuse angle relative to said first sidewall.

5. The dosing device of claim 1, further comprising demarcations on a sidewall of the device to indicate various volumetric units of measure.

6. The dosing device of claim 1, further comprising a portion of the device that is transparent or translucent.

7. The dosing device of claim 1, wherein the means for affixing the dosing device to the gable top container comprises a flange affixed to a sidewall, said flange spaced apart and substantially parallel to the first sidewall.

8. An kit for containing and dosing a flowable composition, the kit comprising
a gable top container for containing a flowable composition, said container having at least one angled upper surface; and
a dosing device for dosing the composition, the dosing device comprising:
a bottom;
a first sidewall connected to the bottom; and
connected to the first sidewall or bottom, means for affixing the dosing device to the gable top container such that the device rests on an angled upper surface of the container.

9. The kit of claim 8, wherein the dosing device further comprises a second sidewall.

10. The kit of claim 8, wherein the second sidewall is trapezoidal in shape.

11. The kit of claim 8, wherein the second sidewall is oriented at an obtuse angle relative to said first sidewall.

12. The kit of claim 8, further comprising demarcations on a sidewall of the device indicating various volumetric units of measure.

13. The kit of claim 8, further comprising a portion of the device that is transparent or translucent.

14. The kit of claim 8, wherein the means for affixing the dosing device to the gable top container comprises a flange affixed to a sidewall, said flange spaced apart and substantially parallel to the first sidewall.

15. The kit of claim 8, wherein the container has a first planar sidewall below the upper angled surface, and when the dosing device rests on the angled upper surface it provides a planar surface that is substantially perpendicular to the first planar surface.
